(19) United States
(12) Patent Application Publication
(10) Pub. No.: US 2008/0312827 A1
(43) Pub. Date: Dec. 18, 2008

(54) Method For Operating A Navigation System

(76) Inventors: Matthias Kahlow, Wurzburg (DE); Jochen Katzer, Bergtshofen (DE)

Correspondence Address: QUARLES & BRADY LLP, 411 E. WISCONSIN AVENUE, SUITE 2040, MILWAUKEE, WI, 53202-4497, US

(21) Appl. No.: 12/131,199

(22) Filed: Jun. 2, 2008

(30) Foreign Application Priority Data
Jun. 13, 2007 (DE) 10 2007 027 820.0
Aug. 14, 2007 (DE) 10 2007 038 463.9
May 6, 2008 (EP) 08 008 500.4

(51) Int. Cl. G01C 21/34

(52) U.S. Cl. 701/209

(57) ABSTRACT

The invention pertains to a method for operating a navigation system. The navigation system includes a data base, in which a geographic region is described by means of machine-readable data, wherein the data base also contains signpost data sets that respectively describe the signpost information of signposts in the geographic region, a route calculating unit for calculating a route, a position finding unit that makes it possible to determine the current position, and at least one output device for outputting at least part of a signpost data set; in the form of an optical, anchor acoustical signpost message in dependence on the current position. The method includes the following steps:

a) determining at least two signpost data sets, wherein a first signpost data set describes the signpost information of a first signpost along the route, and wherein a second signpost data set describes die signpost information of a second signpost that lies behind the first signpost along the route,
b) comparing the determined signpost data sets,
c) deriving the signpost message, wherein the content of the signpost message is determined in dependence on the result of the comparison between the determined signpost data sets, and
d) optically and/or acoustically outputting the signpost message.

### CROSS-REFERENCE TO RELATED APPLICATION

This application claims the priority benefit of German Patent Application No. 10 2007 027 820.0 filed on Jun. 13, 2007, German Patent Application No. 102007 038 463.9 filed on Aug. 14, 2007, and European Patent Application No. 08 008 500.4 filed on May 6, 2008, the contents: of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention pertains to a method for operating a navigation system that may be realized, for example, in the form of a mobile navigation device. In this case, the navigation system comprises a data base, in which a certain geographic region is described by means of machine-readable data. This may concern, for example, the road network of Germany, Europe or another geographic unit. This data base also contains, in particular, signpost, data sets. These signpost data sets contain information that is shown on signposts or direction signs, respectively. This information is generally referred to as signpost information below. The corresponding information of the signposts is usually integrated into digital maps by the suppliers of digital map material such that the information on the signposts can be output in accordance with the respective position.

### BACKGROUND OF THE INVENTION

In addition, the navigation system conventionally features a route calculating unit for calculating a route, a position finding unit for determining the own current position and an output device for outputting information for the user. The output may be realized in an optical fashion, for example, by utilizing a monitor or acoustically, for example, by utilizing a loudspeaker. The output device is suitable, in particular, for outputting parts of the signpost data set in order to support the orientation of the user with the corresponding information.

DE 20 2005 014 631 U1 describes a navigation device, in which signpost messages are output that are derived from the signpost information of the stored signpost data sets. In this output of the signpost messages, it is problematic if a multitude of signpost information is contained in a signpost data set. This is the case; for example, if two, three or more destinations, are shown on the assigned signpost.

In instances in which the signpost data set contains a multitude of signpost information, the signpost message has been derived with two different approaches until now. According to the first approach, the signpost information that ranks first in the signpost data set is always output. This ensures that the signpost message remains short. With respect to the intelligibility of the signpost messages, however, this approach is disadvantageous because the selection of the signpost information ultimately takes place randomly such that the signpost messages may continuously change along the route. In addition, the random selection of the signpost information to be output does not ensure that the information on the signposts that is important for the orientation along the route is actually output. This important information such as, for example, the information on the route destination or the information on a large city in the vicinity of the destination may be suppressed due to the random selection of the signpost information although this information, which is particularly important for the user's orientation along the route, is contained in the corresponding signpost data set.

According to the second approach, all signpost information of a signpost data set is always output. However, this is also disadvantageous with respect to the user's orientation because the important information is mixed with a multitude of unimportant information such that the intuitive perceptibility deteriorates. While driving, the user only has little time to take in and, if applicable, compare the displayed signpost messages with the real information on the signposts. Furthermore, the output of all signpost information of a signpost data set respectively requires a lot of space on a display device such as, for example, a monitor, or a lot of time in case of an acoustic output. This can impair the output of other important information for the user.

### SUMMARY OF THE INVENTION

Based on this state of the art, the present invention aims to propose a new method for operating a navigation system that makes it possible to derive and output signpost messages in an improved fashion. This objective is attained in one embodiment with a method for operating a navigation system. The navigation system includes a data base, in which a geographic region is described by means of machine-readable data, wherein the data base also contains signpost data sets that respectively describe the signpost information of signposts in the geographic region, a route calculating unit for calculating a route, a position finding unit that makes it possible to determine the current position, and at least one output device for outputting at least part of a signpost data set in the form of an optical and/or acoustical signpost message in dependence on the current position. The method includes a) determining at least two signpost data sets, wherein a first signpost data set describes the signpost information of a first signpost along the route, and wherein a second signpost data set describes the signpost information of a second signpost that lies behind the first signpost along the route, b) comparing the determined signpost data sets, c) deriving the signpost message, wherein the content of the signpost message is determined in dependence on the result of the comparison between the determined signpost data sets, and d) optically and/or acoustically outputting the signpost message.

Additional advantages and advantageous embodiments of the subject matter of the invention can be found in the description, in the drawing, and in the claims.

The inventive method is based on the notion that not only one signpost data set, particularly the signpost data set assigned to the current position, is evaluated in order to generate a signpost message, but rather several signpost data sets are taken into consideration. The signpost data sets taken into consideration are respectively assigned to signposts, all of which lie along the precalculated route of the user. This consideration of several, signpost data sets makes it possible to realize an anticipatory treatment of the individual signpost information by comparing the different signpost data sets. This comparison in turn makes it possible to output signpost information with high information content regarding the observance of the route with high priority while signpost information with little or no information content regarding the observance of the route is filtered but.

The inventive method therefore, is carried out by determining at least two signpost datasets that are respectively assigned to signposts along the route. The signpost information in the determined signpost data sets is compared in order to establish, in particular, concurrence in the signpost information of the different signpost data sets. In other words, this comparison of several signpost data sets assigned to the route means that the information of the different signposts is interrelated in an anticipatory treatment.

The comparison of the signpost information of the signposts may be carried out such that it either begins at the start of the route or at the destination of the route. If the analysis of the signpost information begins at the destination of the route, it is advantageous that the destination of the route or a city that lies near the destination and appears in the signpost information is output as early as possible in this fashion. This is a desirable effect because the user most likely knows his destination, but not necessarily intermediate destinations located along the route.

The basis for deriving the current signpost message normally is the signpost information shown on the signpost that is situated closest relative to the current position. However, not all the signpost information of this first signpost is output or a random selection of one specific signpost information is carried out in this case. According to the invention, at least one signpost information is selected from the multitude of signpost information of the first signpost in dependence on the result of a comparison between the determined signpost data sets. The selection of the signpost information to be output therefore does not take place in a purely random fashion, for example, by specifying a certain ranking in the signpost data set, but is rather defined and influenced by the result of the comparison of the signposts situated along the route in the form of an anticipatory treatment.

Lastly, the signpost information is then optically or acoustically output in the inventively processed form.

In the normal mode of the navigation system, the first signpost data set should be assigned to the signpost that is situated closest relative to the current position along the route. The signpost information shown on this closest signpost usually needs to be at least partially output for the user while passing the signpost in order to enable the user to compare the route information of the navigation system with the signpost information of the signposts arranged along the route.

The inventive anticipation of signposts along the route for deriving the signpost message should preferably take into account an uninterrupted string of signposts situated along the route. In other words, the signpost data sets of the second, third, fourth signposts and the remaining uninterrupted sequence of signposts along the route which follow the closest signpost should be evaluated in addition to the closest signpost along the route. In this respect it would be possible; in particular, to respectively evaluate all signpost data sets that are assigned to the signposts along the remaining route in order to derive the signpost messages.

The evaluation of the result of the comparison between the different signpost data sets basically; can be carried out in any suitable way. One variation that can be carried out in a particularly simple fashion consists of respectively searching for concurrences in the signpost information of the signpost data sets to be compared with one another. In this case; all signpost information of a signpost data set that does not concur with the signpost information in an ensuing signpost data set is filtered out. Only the signpost information that remains after this filtering is subsequently taken into account for deriving the signpost message. This type of evaluation makes it possible to generate signpost messages that enable, the users to already orient themselves in a certain direction in a timely fashion. During driving; maneuvers, for which signpost messages are generated, the users respectively receive the same signpost information as long as possible. This prevents the users from having to orient themselves in a new direction in accordance with changing signpost information during each driving maneuver. This increases the subjective certainty of the users as to the fact that they are traveling in the correct direction. In addition, this type of processing signpost messages corresponds to the information intuitively expected by the users. The users know their destination or usually larger cities located near the destination and base their orientation on signposts that show this destination of larger cities situated in the vicinity thereof as early as possible.

If more than two signpost data sets need to be compared with one another and taken into consideration in deriving the signpost message, it is sensible to utilize a comparison result list. In a first step, all signpost information of the first signpost data set that was hot filtered out during the comparison with the second signpost data set is written into the comparison result list. Subsequently the content of the comparison result list is compared to the signpost information of the third signpost data set, and signpost information that does not concur is filtered out. This step-by-step filtering of signpost information from the comparison result list is continued until concurring signpost information can no longer be detected or until no additional signpost data sets exist for the route; the last comparison result list that is not empty therefore contains signpost information that is identical to the information shown on the signposts along a certain segment of the route. This identical signpost information is of particular importance for the orientation of the users and therefore serves for generating the signpost message.

If the comparison result list only contains one signpost information after the filtering process is completed, this signpost information that ultimately was shown successfully on several signposts is respectively output as the signpost message. However, if the comparison result list contains a multitude of signpost information, two different variation may once again be considered for generating me signpost message. According to the first variation, all signpost information that remains in the comparison result list is output adjacent to one another.

In instances in which the comparison result list contains a multitude of signpost information, it would alternatively be possible to always select and output only one signpost information. For example, it would be possible to always respectively select the first signpost information from the comparison result list and to output this signpost information as the signpost message.

If the comparison result list was completely cleared due to the step-by-step continuation of the comparison with additional signpost data sets, this means that no more signpost information that concurs to previous signpost information exists at this location. In this case, a new comparison result list needs to be prepared by comparing additional signpost data sets along the route. It is imperative that the signpost information output with the signpost message then changes at this location.

An especially good orientation of the users is achieved by, outputting the destination. According to one preferred variation of the method, it is proposed to check all signpost data sets to determine if they contain signpost information relating to the destination of the precalculated route. If this is the case; the destination input by the user by means of an input device at the beginning of the route calculation process is output as signpost message.

In the search for concurrences during the comparison of the signpost information of different signpost datasets it would be conceivable to utilize different search strategies for classifying concurrences. One particularly reliable method consists of respectively searching the signpost data sets for signpost information with at least one identical word, at least one identical part of a word, at least one identical word group and/or at least one identical graphic symbol. If a corresponding/identical part is found, both pieces of signpost information, should be classified as concurring and, for example, be subsequently included in the comparison result list.

Depending on the respective national language, local information frequently also contains auxiliary words that do riot allow a significant characterization of the place name. It is therefore particularly advantageous if the corresponding auxiliary words are not taken into account in the comparison of signpost information in order to determine concurrence. To this end, it would be possible, for example, to store auxiliary word lists in a data base. The auxiliary words contained in the auxiliary word list are then filtered out of the signpost information during the comparison of signpost data sets so as to prevent the classification of concurrences due to the detection of identical auxiliary words.

In the basic variation of the method, a search is usually carried out for concurrences in the alphanumerically stored signpost information as it corresponds to the information on the signposts. Under certain circumstances, however, concurrences are not found because place names are frequently abbreviated on signposts. In addition, abbreviations of place names may also differ on successive signposts depending on how much space is available on a signpost. Such instances may, under certain circumstances, still be intercepted by also including parts of the place names in the comparison as described above. However, this additional comparison option also is no longer sensible if the abbreviated place names fall short of a certain minimum length, for example, 5 letters. Consequently, it is not always possible to present to the users a continuous string of sufficiently similar signpost texts although the corresponding information is basically available. This forces the users to orient themselves based on new destinations more frequently. This problem can be solved by classifying two signpost data sets as concurring if both signpost data sets contain concurring metadata. In this case, the metadata consists of data derived from the signpost information.

When comparing the metadata of two signpost data sets, it is particularly advantageous to compare the phonetic transcriptions of the signpost information stored in the signpost data sets. Since place names abbreviated on signs are completely mapped in the metadata, particularly the phonetic transcriptions, it is possible to find more concurrences between the destination information of two signposts.

In addition, the time required for comparing the signposts along the route is reduced in many instances. Since the metadata does not omit any information, but under certain circumstances rather reconstructs information that lacks in reality, significantly fewer comparisons of character strings or parts thereof are required.

The signpost messages basically can be generated at any time. According to a first variation of the method, the signpost messages are already generated and intermediately stored for the entire route before the start of the actual route navigation. The intermediately stored signpost messages are then retrieved from the intermediate memory during the route navigation and are output in dependence on the position. After a signpost message has been output, it can be deleted from the intermediate memory. This type of generating signpost messages relieves the processor unit of the navigation system from calculation processes for generating the signpost messages during the actual route navigation. However, additional storage space for storing signpost messages that were generated beforehand needs to be provided in this case.

As an alternative to this pre-generation of the signpost messages, it would also be possible to generate the signpost messages in real time depending on the position, particularly in relation to individual maneuvering instructions. This makes it possible to save storage space.

If the signpost message is optically displayed for the user, the graphic design of the signpost message, particularly the respective colors, should be adapted to the graphic design of the signpost located at the current position. To this end, it would be possible, for example, to evaluate whether the signpost stands along a freeway or a national highway. Signposts along these two types of roads have characteristic colors (freeway blue/white, national highway yellow/black). The graphic design of the signpost message can be correspondingly adapted in order to provide the users with an intuitive impression of the signpost. In this contexts the color and/or shape of the signpost message also needs to be adapted to different nations because different states usually have differently designed signposts. When traveling along routes that cross borders, the position of the vehicle needs to be evaluated and the color configuration for the country, in which the vehicle is located, needs to be selected.

This and still other objectives and advantages of the present invention will be apparent from the description which follows. In the detailed description below, preferred embodiments of the invention will be described in reference to the accompanying drawings. These embodiments do not represent the full scope of the invention. Rather the invention may be employed in other embodiments. Reference should therefore be made to the claims herein for interpreting the breadth of the invention.

### BRIEF DESCRIPTION OF THE DRAWINGS

The figures show:

FIG. 1, a schematic route of a navigation system with six signpost data sets that are assigned to six signposts along the route;

FIG. 2, the signpost information selected for outputting the signpost messages along the route shown in FIG. 1 in accordance with the state of the art;

FIG. 3, the signpost information selected for outputting the signpost messages along the route shown in FIG. 1 in accordance with the inventive method;

FIG. 4, the display of the first signpost message according to FIG. 3 on a display device;

FIG. 5, the display of the second signpost message according to FIG. 3 on a display device;

FIG. 6, the display of the third signpost message according to FIG. 3 on a display device;

FIG. 7, the display of the fourth signpost message according to FIG. 3 on a display device;

FIG. 8, the display of the fifth signpost message according to FIG. 3 on a display device;

FIG. 9, the display of the sixth signpost message according to FIG. 3 on a display device, and

FIG. 10 an alternative embodiment of a second signpost message according to FIG. 3 on a display device.

### DETAILED DESCRIPTION OF THE EXAMPLE EMBODIMENTS

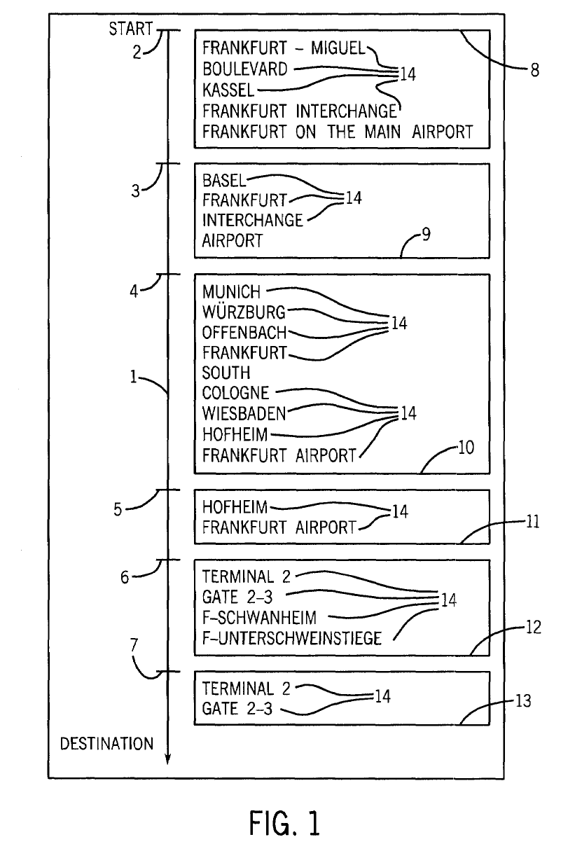

FIG. 1 symbolically shows a route 01 calculated by a navigation system in the form of a motion arrow from the starting point to the destination. In this case, six signposts 02 to 07 are provided along the route 01. The information on the signposts 02 to 07 is stored in a data base of navigation system in the form of signpost data sets. The signpost data sets 08 to 13 assigned to the signposts 02 to 07 are adjacently assigned to the signposts in FIG. 1. Each signpost data set 08 comprises a multitude of signpost information 14 that describes the destination information on the signposts 02 to 07 in text form. As an alternative to this text form, it would also be possible to provide signpost information in the form of graphic symbols.

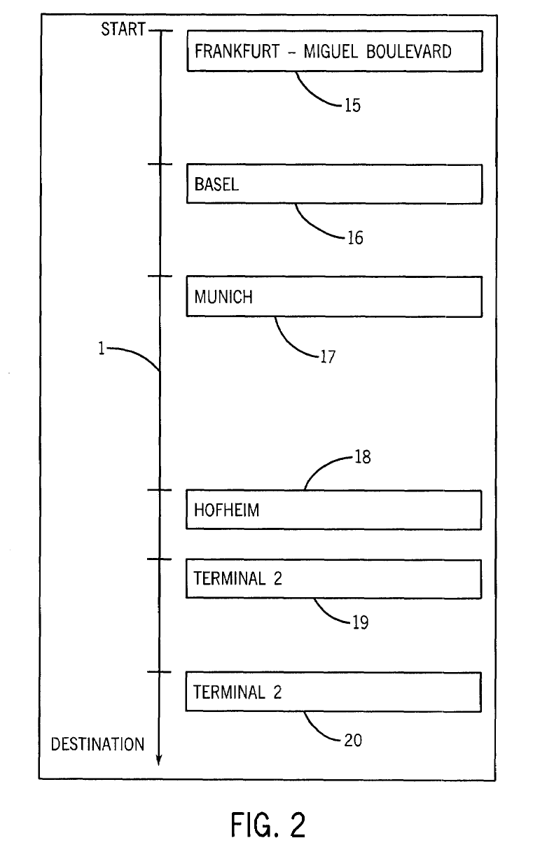

FIG. 2 schematically shows the generation of signpost messages 15 to 20 that are respectively displayed or announced to the user along the route 01 by means of an output device of the navigation system. According to this figure, the first signpost information in the respective list is selected from the signpost data sets 08 and is output in the form of signpost messages 15 to 20 when the vehicle passes the signposts 02 to 07. This example makes it apparent that this type of generating signpost messages is confusing and irritating for the users because they need to alternately orient themselves, for example, in the direction Basel and in the direction Munich at the signposts 03 and 04 although they navigate from a point in downtown Frankfurt in the direction of the Frankfurt airport along the route 01.

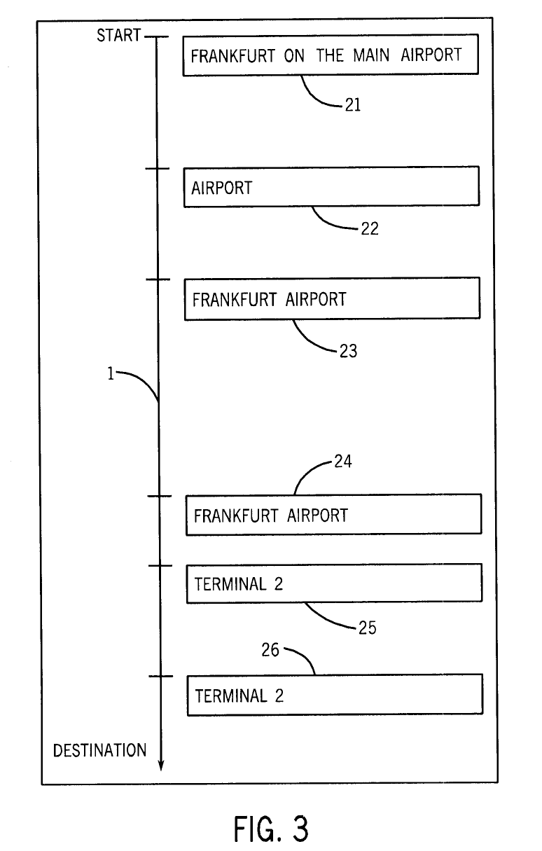

FIG. 3 schematically shows the generation of signpost messages 21 to 26 in accordance with the inventive method. The signpost messages 21 to 26 are once again displayed or announced to the user as the vehicle passes the signposts 02 to 07 along the route 01. Due to the inventive analysis of all signpost data sets 08 to 13 and the proposed comparison of the respective signpost information contained therein, it is recognized that the airport is shown as common destination on the signposts 02 to 05. The destination Frankfurt Interchange, in contrast, only appears twice and all other destinations 14 shown on the signposts 02 to 05 respectively appear only once.

Due to this analysis, the signpost information 14 with the word constituent “airport” that was determined to concur on all four signposts is respectively output as the vehicle passes the signposts 02 to 05.

The information “airport” is missing for the first time on the signpost 06. At this location, the comparison result list is completely cleared because all non-concurring signpost information has beep filtered out. This is the reason why the signpost information of the signpost data sets 12 and 13 is subsequently compared such that the signpost information “Terminal 2” is classified as concurring information. Since this is the only signpost information 14 that concurs in both signpost data sets 19 and 20, this excerpt is output as signpost information 25 and 26 when the vehicle passes the signposts 06 and 07 along the route 01.

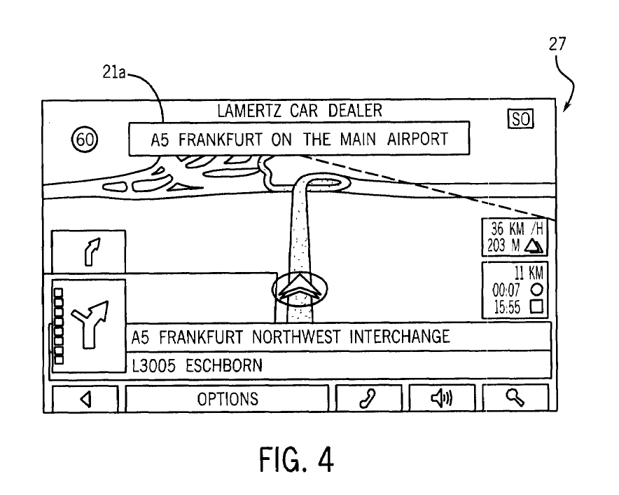

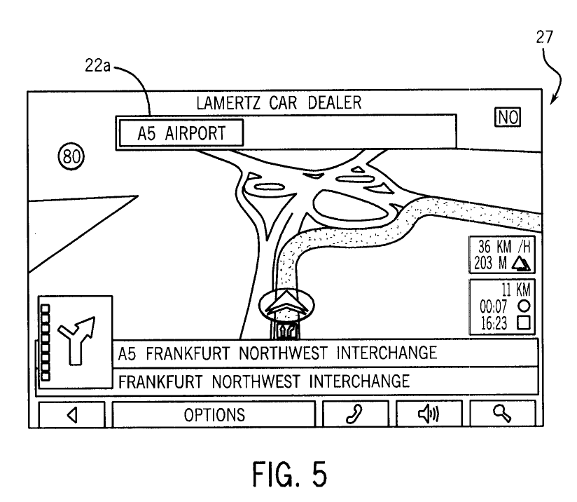

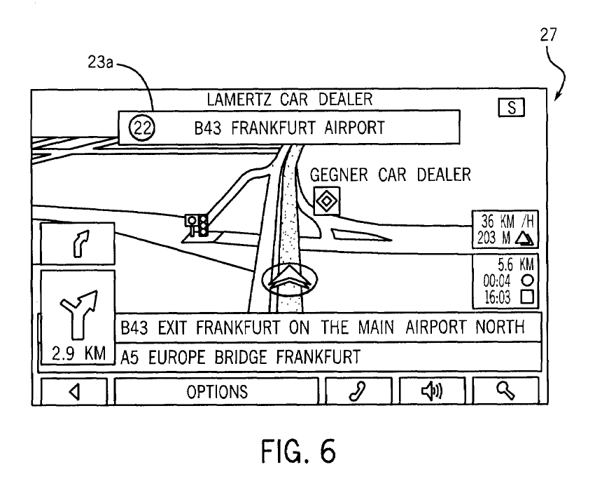

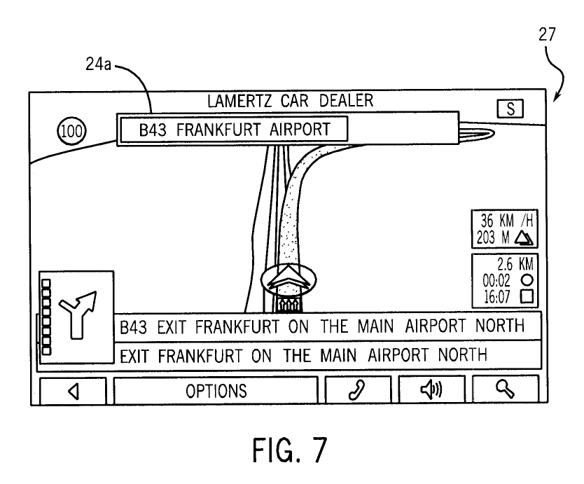

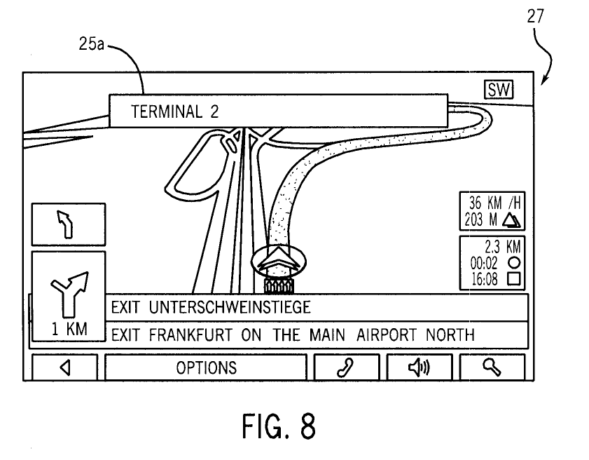

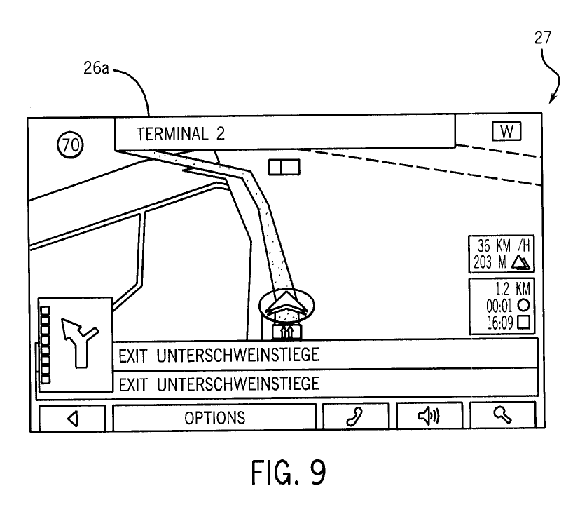

FIG. 4 to FIG. 9 respectively show the image content of the display device 27 of a navigation system such as, for example, a mobile navigation device, while passing the signposts 02 to 07. On the upper edge of the display device 27, the signpost message is respectively displayed in the form of graphics 21a to 26a with the corresponding text of the signpost information 14 selected from the signpost data sets 08 to 13. In this case, the signpost information 14 is accompanied by the corresponding road number of the roads to be navigated with the next maneuver, for example, Freeway A5 or National Highway B43. The graphic design of the signpost information 21a to 26a on the display device 27 is adapted to the respective type of road. This means that signpost messages 21a to 24a that are assigned to signposts along the freeway are designed with white letters on blue background. The signpost messages 25a and 26a that are assigned to signposts along the national highway are designed with black letters on yellow background.

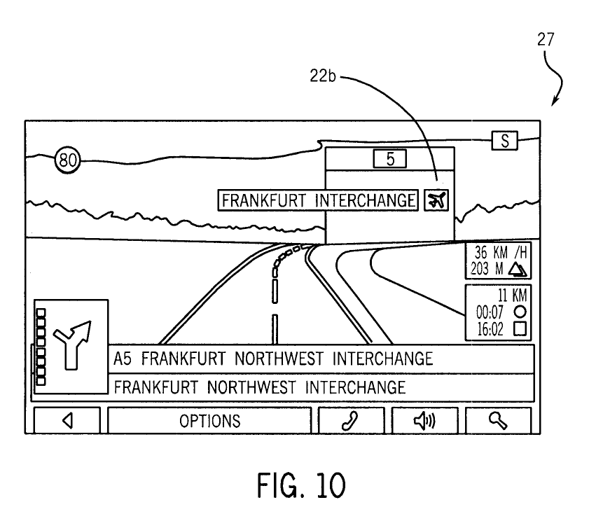

FIG. 10 shows the display device 27 that displays the signpost message in the form of graphics 22b in Reality View.

While there has been shown and described what are at present considered the preferred embodiments of the invention, it will be obvious to those skilled in the art that various changes and modifications can be made therein without departing from the scope of the invention defined by the appended claims.

We claim:

1. A method for operating a navigation system comprising:
a data base, in which a geographic region is described by means of machine-readable data, wherein the data base also contains signpost data sets (08, 09, 10, 11, 12, 13) that respectively describe the signpost information (14) of signposts in the geographic region,
a route calculating unit for calculating a route (01), a position finding unit that makes it possible to determine the current position, and
at least one output device for outputting at least part of a signpost data set in the form of an optical and/or acoustical signpost message in dependence on the current position,
wherein said method comprising the following steps:
a) determining at least two signpost data sets, wherein a first signpost data set describes the signpost information of a first signpost along the route, and wherein a second signpost data set describes the signpost information of a second signpost that lies behind the first signpost along the route,
b) comparing the determined signpost data sets,
c) deriving the signpost message, wherein the content of the signpost message is determined in dependence on the result of the comparison between the determined signpost data sets, and
d) optically and/or acoustically outputting the signpost message.

2. The method according to claim 1, in which the first signpost data set is assigned to the signpost along the route that lies closest relative to the current position.

3. The method according to claim 1, in which the signpost data sets evaluated for deriving, the signpost message are assigned to uninterrupted string of signposts along the route.

4. The method according to claim 1, in which the signpost message is derived by comparing the signpost information of at least two signpost data sets assigned to two consecutive signposts along the route, wherein the signpost information of the first signpost data set that does not concur with any signpost information in the second signpost data set is filtered out.

5. The method according to claim 4, in which the signpost information of the first signpost data set that remains after the filtering is intermediately stored in the form of a comparison result list, wherein the comparison result list is additionally used for deriving the signpost message.

6. The method according to claim 5, in which the filtering of signpost information from the comparison result list of the first signpost data set in the form of a comparison with additional signpost data sets assigned to an uninterrupted string of signposts along the route is continued until concurring signpost information can no longer be detected or until no additional signpost data sets exist for the route, wherein the signpost information of the last non-empty comparison result list is used for deriving the signpost message.

7. The method according to claim 6, in which all signpost information of the last non-empty comparison result list is output as signpost message.

8. The method according to claim 6, in which exactly one signpost information, particularly the respectively first signpost information of the last non-empty comparison result list, is output as signpost message.

9. The method according to claim 4, in which a new comparison result list is prepared by comparing additional signpost data sets after the comparison result list has been cleared.

10. The method according to claim 1, in which signpost data sets are checked to determine whether they contain the destination of the route as signpost information, wherein the destination is output as signpost message in this case.

11. The method according to claim 1, in which two pieces of signpost information are classified as concurring if the respective pieces of signpost information contain
a) at least one identical word and/or
b) at least one identical word constituent and/or
c) at least one identical word group and/or
d) at least one identical graphic symbol.

12. The method according to claim 1, in which auxiliary words, particularly prepositions, are not taken into consideration in the comparison of signpost information in order to determine concurrences.

13. The method according to claim 1, in which two signpost data sets are classified as concurring if both signpost data sets contain concurring metadata, wherein the metadata is derived from the signpost information.

14. The method according to claim 13, in which the phonetic transcription of the signpost information stored in the signpost data sets is compared during a comparison of the metadata of two signpost data sets.

15. The method according to claim 1, in which all signpost messages to be output along the route are derived before the start of the route navigation, wherein the individual signpost messages are intermediately stored until they are output in dependence on their position.

16. The method according to claim 1, in which individual signpost messages are derived in dependence on the position, particularly for individual maneuvering instructions.

17. The method according to claim 1, in which the graphic design of the signpost message that is output in dependence on the position, particularly the colors of the sign post message, corresponds to the graphic design of the signpost provided in the current position.
